(19) United States
(12) Patent Application Publication
(10) Pub. No.: US 2022/0090927 A1
(43) Pub. Date: Mar. 24, 2022

(54) Multi-Hazard Spatio-Temporal Zone-Based Evacuation Management Platform

(71) Applicant: Genasys Inc., San Diego, CA (US)

(72) Inventors: Robert Shear, Albany, CA (US); Charles Crocker, San Francisco, CA (US); Jeff Saunders, San Mateo, CA (US); Alan Williams, Novato, CA (US)

(21) Appl. No.: 17/482,008

(22) Filed: Sep. 22, 2021

Related U.S. Application Data
(60) Provisional application No. 63/081,805, filed on Sep. 22, 2020.

(51) Int. Cl. G01C 21/34; G01C 21/36

(52) U.S. Cl. CPC G01C 21/3461; G01C 21/3492; G01C 21/367; G01C 21/3676; G01C 21/3638

(57) ABSTRACT

Systems and methods providing for zone-based evacuation management. The systems and methods involve allowing a user to select zones from a user interface. The zones properties may be modified by the user. The user may create evacuation pre-plans for selected zones for different types of incidents. Different scenarios may be used in the creation of the plan. The scenarios may use simulation models to determine the affected zones and the rate of spread of the incident. The systems and methods may also generate and send notifications and alerts to the people residing within the affected zones as well as police departments and fire departments with jurisdiction over the affected areas.

### CROSS REFERENCE TO RELATED APPLICATIONS

The application claims benefit of priority to U.S. provisional patent application Ser. No. 63/081,805, filed Sep. 22, 2020, and the entire disclosure of which is hereby incorporated by reference in this document.

### BACKGROUND

Protective actions such as evacuations and shelter-in-place have become more important to the safety of the population in recent years. Emergency planning for incidents such as pandemics, hurricanes, fires, floods and tsunamis need to be in place before an incident occurs. During evacuation planning, multiple cities, state, and federal agencies must work together in order to implement a successful evacuation.

Agencies, emergency services, as well as individuals and families need to understand the different evacuation scenarios for their specific zone in order to evacuate in the most efficient way possible. Communication between agencies and the public is necessary to ensure the safe evacuation of the entire population.

### SUMMARY

Described herein is an exemplary system and methods for zone-based incident training, simulation, planning and real-time incident and evacuation management. In one example embodiment, a system may display, via a user interface, a map of a geographical area. The geographical area may have multiple predefined contiguous zones. A predefined contiguous zone may define an area of the map having geographic boundaries. The map may be displayed by the user interface showing a road network and multiple building structures. The user interface may be configured for receiving a selection of one or more of the predefined contiguous zones. The user interface may be configured for modifying one or more attributes associated with a particular zone.

In another example, a computer-implemented method may include displaying, via a user interface, a map of a geographical area. The geographical area may have multiple predefined contiguous zones. Each predefined contiguous zone may define an area of the map having geographic boundaries. The displaying may include showing a road network and multiple building structures. The user interface may be configured for receiving a selection of one or more of the predefined contiguous zones, and in some examples the method may include such receiving. The user interface may also be configured for modifying one or more attributes associated with a particular zone, and in some examples the method may include such modifying.

In another example, a non-transitory computer storage medium may include instructions to be executed by a system having one or more processors, which instructions may cause the one or more processors to perform operations. For instance, the instructions may cause the one or more processors to display, via a user interface, a map of a geographical area. The geographical area may have multiple predefined contiguous zones. Each predefined contiguous zone may define an area of the map having geographic boundaries. The instructions that cause the one of more processors to perform such displaying may cause the one or more processors to show a road network and multiple building structures. The instructions may cause the one of more processors to receive a selection of one or more of the predefined contiguous zones, and/or in some examples the user interface may be configured for such receiving. The instructions may cause the one of more processors to modify one or more attributes associated with a particular zone, and/or in some examples the user interface may also be configured for such modifying.

Further areas of applicability of the present disclosure will become apparent from the detailed description, the claims and the drawings. The detailed description and specific examples are intended for illustration only and are not intended to limit the scope of the disclosure.

### BRIEF DESCRIPTION OF THE DRAWINGS

These drawings and the associated description herein are provided to illustrate specific embodiments of the invention and are not intended to be limiting.

FIG. 1A shows an example of a multi-hazard spatio-temporal zone-based evacuation management platform in accordance with aspects of the present disclosure.

FIG. 1B shows an example of an evacuation platform core in communication m accordance with aspects of the present disclosure.

FIG. 2 shows an example of an evacuation planning system in accordance with aspects of the present disclosure.

FIG. 3 shows an example of an overview of a process for displaying intersection travel counts of an evacuation plan for a selected zone in accordance with aspects of the present disclosure.

FIG. 4 shows an example of an overview of a process for displaying intersection travel counts of an evacuation plan for a selected zone in accordance with aspects of the present disclosure.

FIG. 5 shows an example of an overview of a process for displaying intersection travel counts of an evacuation plan for a selected zone in accordance with aspects of the present disclosure.

FIG. 6 shows an example of an overview of a process for alerting residence of an emergency and providing an evacuation plan for effected zones in accordance with aspects of the present disclosure.

FIG. 7A shows an example interface of an evacuation planning system in accordance with aspects of the present disclosure.

FIG. 7B shows an example interface of an evacuation planning system in accordance with aspects of the present disclosure.

FIG. 8 shows an example interface of an evacuation planning system in accordance with aspects of the present disclosure.

FIG. 9 shows an example interface of an evacuation planning system in accordance with aspects of the present disclosure.

FIG. 10A shows an example interface of an evacuation planning system in accordance with aspects of the present disclosure.

FIG. 10B shows an example interface of an evacuation planning system in accordance with aspects of the present disclosure.

FIG. 10C shows an example interface of an evacuation planning system in accordance with aspects of the present disclosure.

FIG. 11 is a diagram illustrating an exemplary computer that may perform processing in some embodiments and in accordance with aspects of the present disclosure.

FIG. 12A shows an example interface of an evacuation planning system in accordance with aspects of the present disclosure.

FIG. 12B shows an example interface of an evacuation planning system in accordance with aspects of the present disclosure.

FIG. 12C shows an example interface of an evacuation planning system in accordance with aspects of the present disclosure.

FIG. 12D shows an example interface of an evacuation planning system in accordance with aspects of the present disclosure.

FIG. 12E shows an example interface of an evacuation planning system in accordance with aspects of the present disclosure.

FIG. 12F shows an example interface of an evacuation planning system in accordance with aspects of the present disclosure.

FIG. 12G shows an example interface of an evacuation planning system in accordance with aspects of the present disclosure.

FIG. 12H shows an example interface of an evacuation planning system in accordance with aspects of the present disclosure.

FIG. 12I shows an example interface of an evacuation planning system in accordance with aspects of the present disclosure.

FIG. 12J shows an example interface of an evacuation planning system in accordance with aspects of the present disclosure.

FIG. 12K shows an example interface of an evacuation planning system in accordance with aspects of the present disclosure.

FIG. 12L shows an example interface of an evacuation planning system in accordance with aspects of the present disclosure.

FIG. 12M shows an example interface of an evacuation planning system in accordance with aspects of the present disclosure.

FIG. 12N shows an example interface of an evacuation planning system in accordance with aspects of the present disclosure.

### DETAILED DESCRIPTION

In this specification, reference is made in detail to specific embodiments of the invention. Some of the embodiments or their aspects are illustrated in the drawings.

For clarity in explanation, the invention has been described with reference to specific embodiments; however, it should be understood that the invention is not limited to the described embodiments. On the contrary, the invention covers alternatives, modifications, and equivalents as may be included within its scope as defined by any patent claims. The following embodiments of the invention are set forth without any loss of generality to, and without imposing limitations on, the claimed invention. In the following description, specific details are set forth in order to provide a thorough understanding of the present invention. The present invention may be practiced without some or all of these specific details. In addition, well known features may not have been described in detail to avoid unnecessarily obscuring the invention.

In addition, it should be understood that steps of the exemplary methods set forth in this exemplary patent can be performed in different orders than the order presented in this specification. Furthermore, some steps of the exemplary methods may be performed in parallel rather than being performed sequentially. Also, the steps of the exemplary methods may be performed in a network environment in which some steps are performed by different computers in the networked environment.

Some embodiments are implemented by a computer system. A computer system may include a processor, a memory, and a non-transitory computer-readable medium. The memory and non-transitory medium may store instructions for performing methods and steps described herein.

The following generally relates to a system for providing planning, training, collaboration, and communication for evacuation events. The system and methods provide for a collaborative, interactive, data driven platform for cross-agency agreement, planning, and training. One example of the system in accordance with aspects described herein may include a multi-hazard spatio-temporal zone-based evacuation management platform. The multi-hazard spatio-temporal zone-based evacuation management platform 100 may include easy to use and understand community applications that engage and educate citizens. The multi-hazard spatio-temporal zone-based evacuation management platform 100 may be used to create a frictionless stakeholder communication platform among different agencies. The system provides a platform for allowing many users from different organizations to share incident planning information thereby allowing a multi-agency coordinated response to an incident for training or live incidents.

Thus, the system and/or platform may simulate the occurrence of an incident or incidents. An incident may occur over one or more zones. In some examples, the zones may be contiguous. Moreover, in some examples, the zones may be predefined. In some embodiments, the zones may not be user-generated or user created. For instance, a user may be presented with a map showing multiple zones. In some examples, shown and described below in additional detail, one particular zone may be selected; in some examples, more than one particular zones may be selected, while other zones are unselected. When selected, in some examples, a particular zone may be visually distinguishable from other zones. In one embodiment, the selected zone may be highlighted or shown in a different color shade than other zones. In some examples, a user may select one or more particular zones of interest.

In some examples, the zones or each respective zone may be associated with a neighborhood, township, municipality, city, or parts or sections thereof. In some examples, such predefined zones may include geographical features, some of which features may be man-made, such as a road network and/or building structures, cordon areas, etc., or natural features such as rivers, mountains, etc. The system and/or platform may take into account such features and may according show one or more of features on a map. In some examples, such predefined zones may have been previously determined to be of importance to particular users or subsets of users, for example, based on one or more geographic locations associated with the particular users (e.g., where such users live or work or travel to or happen to be at during a particular time).

In some examples, the system may provide a user interface. The multi-hazard spatio-temporal zone-based evacuation management platform may provide accessibility to the user interface by multiple users that have different user roles and privileges for accessing, viewing and editing various zone attributes, and for performing certain functionality in the system. For instance, a user interface may allow user creation and/or modification of information related to attributes associated with a particular zone. In some examples, the user interface may facilitate or allow the creation of an incident. The incident may an actual event occurring in real-time in some examples, or simulated in other examples. The incident may be created through a source external to the platform or system, such as through a real-time emergency notification, and/or by the system or by user input in the case of a real-time emergency, or selected by the user (e.g., out of pre-set incident types selectable through the system or platform) to be run as a simulation. In some examples, the incident may be simulated over a time period.

In some examples, the system may simulate the occurrence of a time-based incident occurring over one or more of the predefined contiguous zones. In some examples, such simulating may be based on an actual incident but may nevertheless include associated simulated operations. In some examples, such simulating the occurrence may include creating an incident (which may be a real incident or a not an actual, currently ongoing event). In some examples, such creating may occur via the user interface. In some examples, and as explained further below, the creating may include one or more of placing an incident point on the map, selecting an incident type, running a perimeter simulation or radius model, building a zone selection set from the perimeter simulation or radius model, adding details and/or retrieved predefined information to the incident. In some examples, the added details may include start time, end time, start data, end date, name, description and or an assigned status of the incident, etc. In some examples, such simulating the occurrence may also include adding or removing zones from the selection set based on evacuation time and by clicking on the zones to be added or removed. In some examples, such simulating the occurrence may also include selecting one or more communication channels, verifying a user's authority to send, and sending, through the one or more communication channels, alerts, notifications, evacuation recommendations, egress points, evacuation arrival points, and/or critical evacuation facilities. In some examples, the channels may include stakeholders, social media and/or mobile applications, etc.

In some examples, such simulating the occurrence may include determining the occurrence of a real-time incident. In some examples, simulating or determining the occurrence may include receiving geo-location information of the real-time incident. In some examples, the operation of simulating the occurrence may also include presenting the occurrence of the real-time incident occurring over one or more of the predefined contiguous zones, based at least in part on the geo-location information. In some examples, such presenting may include using the user interface to display such information. In some embodiments, an occurrence may be depicted as a graphical shape indicating the area of the real-time incident. In some examples, based at least in part on the determination of the occurrence of the real-time incident, alerts and notifications may be provided to particular users. And in some examples, such users may be pre-configured to receive the alerts and notifications for the type of the incident and the zones in which the incident is occurring or is predicted to occur.

By way of example, a simulated incident may be a fire, flood, active shooter, hazardous material, and/or dam inundation. Thus a multi-hazard spatio-temporal zone-based evacuation management platform 100 may provide for hyper-local planning at scale, including generation of dynamic reports, training on emergency scenarios including fire, earthquake, floods, tsunami, nuclear fallout, terrorist attacks, hazardous materials, dam inundation, coastal inundation, active shooter, bomb threat, pandemic or combination thereof and generating evacuation recommendations.

Whether for an actual or simulated incident, in some examples, a user may identify an incident point or location on the map. In some embodiments, such the user may perform such identifying via the user interface. In other examples, the incident may be imported from a non-user source, such as through an emergency notification. In some examples, an incident point may be identified in one or more of the predefined contiguous zones. In some embodiments, the incident may have a center point and/or an area of initial incident coverage. An incident type may be selected or assigned to the incident (e.g., a fire). After setting up additional details about the incident, in some examples, the user interface may depict the incident via a graphical indication over the predefined contiguous zones. For example, in the simulation of a fire incident the system would depict the spread of the fire over a time period based on simulated weather conditions, such as wind speed, time of day, temperature, humidity. The user may then observe how the growth or change of the area of the incident would impact the zones and particularly, how the incident would impact persons, structures, evacuation routes, and so forth in the affected zones. The system may estimate the incident growth over a period of time and based on the spread or growth (such as a fire perimeter), the system may trigger actions to be taken by the system such as providing electronic communication as described below.

For a simulated or actual real-time incident, the multi-hazard spatio-temporal zone-based evacuation management platform provides the assignment of communication channels to provide electronic information to external systems and people when the simulated incident is modeled, or an actual real-time incident occurs. For example, the system may provide for the selection and assignment of communication channels such as e-mail communication, SMS, messaging, commercial mapping and routing tools, social media application. When the simulated or actual real-time incident occurs, the system may use the communication channels to provide information to users, people and external systems to distribute important information about the incident. For example, the system may provide via the communication channels alerts, notifications, evacuation recommendations, egress points, evacuation arrival points, and/or critical evacuation facilities. Moreover, the system may allow some users or systems to receive some information, while other users or systems may receive other types or information content.

As part of training, simulation and monitoring a real-time incident, the system may provide functionality for route suggestion and traffic control points. In planning evacuation routes, and likely points of vehicle flow for movement away from an incident, the system may allow for the evaluation of likely vehicle travel within one or more zones impacted by the incident. For example, the multi-hazard spatio-temporal zone-based evacuation management platform may determine route intersection travel counts for the one or more zones. In some examples, the platform or system may present the intersection travel counts as a graphical indication at intersection points of the road network within a zone or within more than one zone. In some examples, such presenting may include or be based at least in part on displaying, via the user interface, the intersection travel counts. The route intersection travel counts may be determined based on the number of structures or address points and/or the number of vehicles residing at each structure or address point within the one or more zones and the intersection points which each vehicle travels through during an evacuation. The route intersection travel counts of intersection points may increase as more vehicles are added to the route between intersection points. The number of vehicles within the one or more zones may be determined based on a time of day and an estimated population of the one or more zones at that particular time of day. The estimated population may be based on a commuting population, the number of businesses and retail locations within the one or more zones, events occurring within the one or more zones and the estimated number of attendees and/or the populations at facilities within the one or more zones. The user interface allows a user to understand the likely flow of traffic and plan accordingly. For example, a police agency may identify where to set up traffic control points or where to possibly block off streets to achieve an effective flow of traffic.

In some embodiments, the number of vehicles residing at each structure are user adjustable. The user may select a zone or one or more structures within a zone that they wish to modify. The user may then provide the user interface with a multiplier for the selected zone or structures. The multiplier may be used to adjust the number of vehicles residing at the selected zone or structures. The user interface may also display a slide bar associated with the multiplier for the selected zones or structures. The user may interact with the slide bar, and the positioning of the slide bar may be used to determine the multiplier to be associated with the selected zones or structures.

Relatedly, method embodiments described herein may include, or the system may perform the operation of, receiving a selection of a zone or one or more structures within a zone; receiving a multiplier for the selected zone or structures; and adjusting the number of vehicles residing at the selected zone or structures based on the received multiplier. In some examples, one or more of such operations may be based at least in part on user actions made via the user interface. In some examples, the system may receive (e.g., via the user interface) an interaction with the slide bar. In some examples, the system may adjust the displayed intersection travel counts based on the interaction with the slide bar. For instance, a user may user the user interface to change the positioning of the slide bar, and the system may adjust the displayed intersection travel counts based on that changed position.

In some embodiments, the user and/or the system (based at least in part, in some examples, on user input) may select one or more exit points for the one or more zones. The system (in some examples, based at least in part on user input) may then determine one or more routes from the building structures within the one or more zones to the one or more exit points. The system (in some examples, based at least in part on user input) also may select the route (or multiple routes) with, or based at least in part, the shortest distance and travel time for each building structure to the exit points. The system may also estimate the number of vehicles at each building structure. In some examples, the system may also use one or more of these selected routes, and/or the estimated number of vehicles, to determine the number of vehicles that travel through each intersection point. In some examples, a route may correspond to a particular zone. In some examples, the route may correspond to several zones. In some examples, the route may be within a particular zone. In some examples, the route may cross several zones. In some examples, the user may select one or more particular zones of interest, through which a route may be or cross.

The multi-hazard spatio-temporal zone-based evacuation management platform may provide an application programming interface for allowing external applications or systems to interact with the multi-hazard spatio-temporal zone-based evacuation management platform. For example, the multi-hazard spatio-temporal zone-based evacuation management platform may provide a function for receiving requests of information related to a particular zone based on a received zone identifier. The multi-hazard spatio-temporal zone-based evacuation management platform would provide a response with information including one or more of a count value for an estimated day population, an estimated night population, an estimated number of vehicles located in the zone during a day time period, an estimated number of vehicles located in the zone during a night period, a number of structures or address points, an array of geo-locations of traffic control points, an array of geo-locations of arrival points, and/or an array of zone routes.

The multi-hazard spatio-temporal zone-based evacuation management platform allows the generation of an incident response plan in the form of electronic reports, such as a pdf or other electronic format. The response plan covers one or more of the predefined zones, and provides information related to a planned response for a particular incident type. The incident response plan may depict one or more maps. The incident response plan for example, may depict evacuation routes, structures, bunkers, shelters, transportation hubs, schools, safe haven areas, refuge areas, staging areas, hospitals, event centers, and other information that a user may add to a zone that is of importance or relevance to the response plan.

In some embodiments, external signals such as satellite imagery and real-time 911 dispatch call logs may be used to predict incidents and proactively notify officials, agencies or emergency services autonomously.

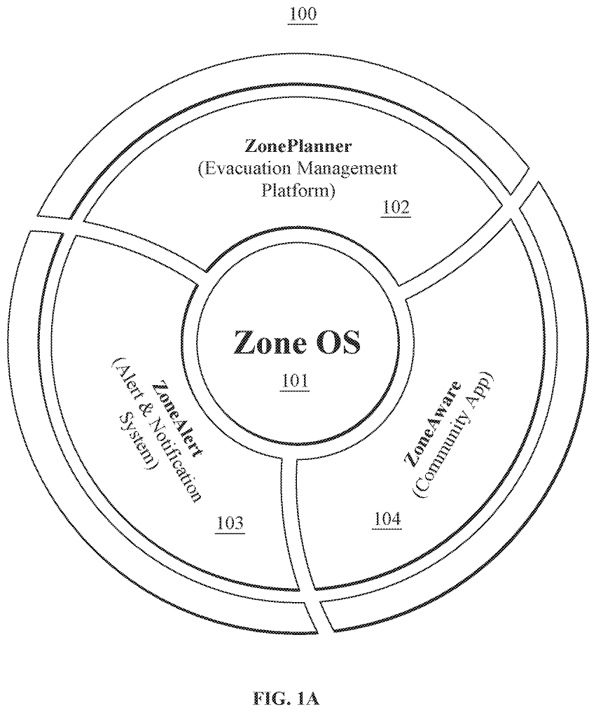

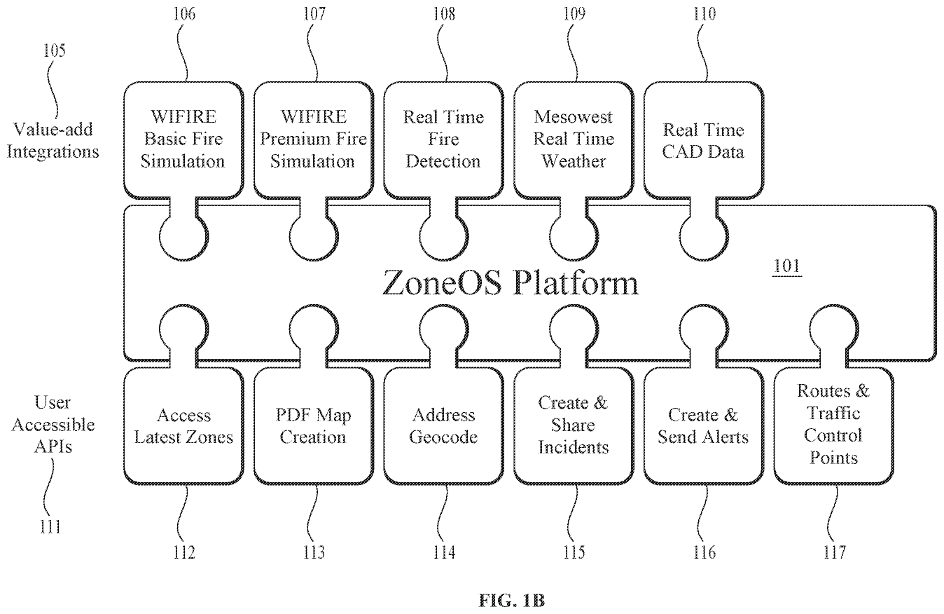

FIG. 1A shows an example of a multi-hazard spatio-temporal zone-based evacuation management platform 100 in accordance with aspects of the present disclosure. The multi-hazard spatio-temporal zone-based evacuation management platform 100 may comprise one or more systems modules, including an Evacuation Platform Core (EPC) 101, an Evacuation Planning System (EPS) 102, an Alert and Notification System (ANS) 103, and one or more community applications 104.

EPC 101 may provide interactive functionality for analyzing, collaborating, communicating and alerting users related to events or incidents (e.g., actual or simulated fire scenario over multiple zones, earthquake, floods, tsunami, nuclear fallout, terrorist attacks, hazardous materials, dam inundatiOn, coastal inundation, active shooter, bomb threat, pandemic (i.e. Covid-19). EPC 101 may be a standalone application, a web-based system and may communicate with participating partner agencies, third party simulation applications, databases storing and social media. EPC 101 may also include a set of APIs or microservices that others may build applications upon.

EPS 102 may provide interactive functionality for agencies and users (such as fire fighters, law enforcement officers (LEO), and the Office of Emergency Services (OES)) to collaboratively build and maintain evacuation plans. EPS 102 may also be used to perform training based off of evacuation simulations and scenarios.

ANS 103 may provide system functionality for alerting and notifying users in relation to planned or actual events. For example, the system may provide alerts allowing fire fighters, LEO and OES to communicate evacuation plans to residents of the community. ANS 103 may also interact and provide electronic communications to social media and other integrated emergency systems regarding event information, such as change in status of individual zones.

The community applications 104 may be applications that are integrated with or use system application programming interfaces (APIs) to interact with the system. For example, a community application may be an agency software system that interacts with the system 100 to receive event and zone status information. A link to the community applications 104 may be shared over social media when an evacuation is issued or updated.

The multi-hazard spatio-temporal zone-based evacuation management platform 100 may be used by a number of different users with different levels of access and the system may provide different functionality based on each user role. The system I 00 provides access and functionality to system users based on the user role. Each user role requires specific knowledge and includes responsibilities of the user roles. User roles, for example, may include an administrator role, public user, Fire Captain or Battalion Chief, Police Captain or Chief, Fire/Police/OES User or Mutual Aid Fire/Police/OES Member, Community Representative and Community Member.

Fire Captains and Battalion Chiefs may have a responsibility to ensure safe evacuation and return of displaced residents. They may need to understand the number of people, structures and areas under threat. They may also need to understand how to remove people from harm's way while identifying measures to control incident spread.

Police Captains and Chiefs may be required to declare an evacuation and ensure orderly and safe evacuation of an area. They may also be required to ensure that ingress and egress of vehicles is managed through traffic control points. For example, a traffic control point may be a location about a road network, such as at a particular intersection where vehicle or pedestrian control is needed in a pre-defined zone.

Fire/Police/OES Users and Mutual Aid Fire/Police/OES Members may need to understand the number of people, structures, vehicles and areas under threat. They may also need to understand how to remove people from harm's way while identifying measures to control incident spread. Ensuring orderly and safe evacuation of an area, as well as managing ingress and egress of vehicles through traffic control points may need to be performed.

Community Representatives may be required to interface between the community and government agencies (fire, police, OES). Volunteers may need to be educated about disaster preparedness for hazards and trained in basic disaster response skills such as fire safety, light search and rescue, team organization and disaster medical operations.

Community Members may need to access and understand when and where public safety zone statuses change. They may need to understand how to quickly and easily leave a zone when evacuation is ordered, as well as be able to identify necessary resources during evacuation or other public safety events.

FIG. 1B shows an example of an EPC 101 in communication with external applications and systems through the use of APIs in accordance with aspects of the present disclosure. EPC 101 may communicate with one or more value-add integrations 105 and one or more user accessible APIs 111. The value-add integrations 105 may include WIFIRE Basic Fire Simulation 106, WIFIRE Premium Fire Simulation 107, Real Time Fire Detection 108, Mesowest Real Time Weather 109, Real Time CAD Data 110.

WIFIRE Basic and Premium Fire Simulation 106, 107 are examples of external applications or computerized services that the system 100 may integrate with to obtain models and information to simulate by the system 100 fire-based incidents or events. Real Time Fire Detection 108 is an example of external applications or computerized services that the system 100 may integrate with to obtain information related to the detection of real-time fire events. The system 100 may integrate with other external systems that provide information of other real-time incidents or events. Mesowest Real Time Weather 109 is an example of external or computerized services where the system 100 may obtain real-time weather information. Real Time Computer Aided Dispatch (CAD) data 110 is an example of an external application or computerized services where the system 100 may obtain CAD data. For example, the CAD data include electronic information representing location and status of 911 calls and other emergencies.

The system 100 may provide APIs for use by external systems and applications allowing these external systems to interact with the system 100. For example, the system 100 may provide APIs for Access to Latest Zones 112, PDF Map Creation 113, Address Geocode 114, Create & Share Incidents 115, Create & Send Alerts 116 and Routes & Traffic Control Points 117. The Access Latest Zones API 112 provides functionality for the retrieval of information related zones. The PDF Map Creation API 113 provides functionality for the creation of electronic maps. The Address Geocode API 114 provides functionality for address-based lookups and reverse-geocoding. The Create & Share Incidents API 115 provides functionality for the creation and sharing of information related to incidents or events. For example, this API provides a unified and consistent way to access, create or update emergency incidents (e.g., fires, earthquakes, active events, floods, coastal inundation, hazardous materials release, etc.). The Create and Send Alerts API 116 provides functionality for the creation and sending of alerts. For example, this API provides a unified and consistent way to send messages to communication channels and system 100 users or subscribers. Communication channels include email distribution lists, commercial mapping and routing tools (e.g., Waze, social media applications (e.g., Facebook, Instagram and Twitter). The Routes & Traffic Control Points API 117 provides functionality for creation and management of evacuation routes and traffic control points. For example, the system 100 may receive geo-location information such as address, GPS, latitude/longitude coordinates and/or geo-location information describing areas/polygons and provide output information describing routes and traffic control points associated with the received geo-location information.

The system 100 APIs may require certain parameters or fields when performing the API function. For example, some input parameters would include: a ZoneID which may be an integer value or alphanumeric value describing a unique identifier (ID) for a particular zone, a CountyID which may be a value describing a unique county (and is similar to a county FIPS code which is a five-digit Federal Information Processing Standards code which uniquely identifies counties and county equivalents), a CityID which may be an integer or alphanumeric value describing a lead incorporated city for a particular zone, IncidentID which may be an integer or alphanumeric value describing a unique ID for an incident, AlertID which may be an integer or alphanumeric value describing a unique ID for an alert, and geo-location information (e.g. address, lat/long, GPS coordinates, city, state, country, polygonal areas, beginning and ending route locations, and any combination thereof).

For example, the Access Latest Zones API 112 may provide an application programming interface having a function for allowing processing requests for information related to a particular zone-based on a received zone identifier (i.e., the ZoneID). In response to the received request for the particular zone, the system 100 may provide a response of an electronic data bundle (e.g., a JSON document) including one or more fields with a count value for an estimated day population, an estimated night population, an estimated number of vehicles located in the zone during a day time period, an estimated number of vehicles located in the zone during a night period, a number of structures or address points, an array of geo-locations of traffic control points, an array of geo-locations of arrival points, and an array of zone routes.

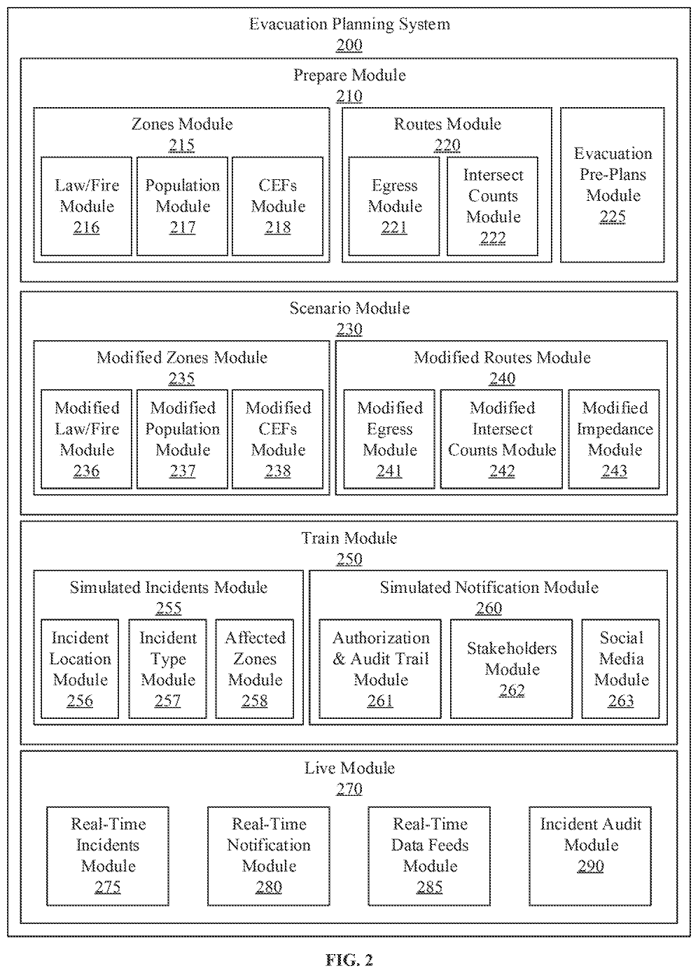

FIG. 2 shows an example of an EPS 200 in accordance with aspects of the present disclosure. EPS 200 may comprise a prepare module 210, a scenario module 230, a train module 250 and a live module 270. The modules describe groupings of functionality provided by the system 100.

Prepare module 210 may comprise zones module 215, routes module 220 and evacuation pre-plans module 225. The zones module 215 may be used to collect zone statistics and collaborate on zone responsibilities and information. Zones module 215 may include law/fire module 216, population module 217 and containment evacuation and flooding systems (CEFS) module 218. The population module 217 may be used to determine the day population and night population of a zone. The number of structures or address points, area (acres/hectares) and critical evacuation facilities may also be determined by the zones module 215. Fire Department facilities and resources, Law Enforcement stations and resources and other special considerations may be determined by the law/fire module 216 and provided to the routes module 220 and the evacuation pre-plans module 225 to prepare and plan for potential traffic control points, evacuation arrival points and evacuation routes.

Routes module 220 may include egress module 221 and intersect counts module 222. Routes module 220 may generate potential evacuation routes and identify traffic control points. The traffic control points may be determined based on the type of incident, number of officers available, number of cones or barricades available, and/or the recommended/minimum number of traffic control points needed. Different scenarios may be taken into consideration in the determining of the locations and number of traffic control points. Real-time data may be used to determine if traffic control points need to be moved, added or removed all together. Egress module 221 may determine which potential egress routes and arrival points are the safest, shortest/closest or fastest from individual structures.

Intersect counts module 222 may be used to estimate the number of vehicles passing through each intersection in a zone. The intersect counts module 222 may use population estimates from the population module 217 in combination with the routes generated by the egress module 221 to determine the intersection travel counts for each intersection along the egress routes.

Evacuation pre-plans module 225 may collect and populate pre-plan zone information for fire (life and structure safety) and law enforcement (traffic). The evacuation pre-plans module 225 may engage stakeholders to refine zone-specific leadership, responsibilities, and data. Information from the zones module 215 and routes module 220 may be used by the pre-plans module 225 in the generation and publication of evacuation pre-plans. The user may modify the evacuation pre-plan by adding/selecting/updating special conditions, critical evacuation facilities, traffic control points, resources for traffic control points, potential routes, prioritized routes based on threat direction, potential arrival points by map or by address, related links or other properties or parameters of the evacuation preplan.

Scenario Module 230 may comprise, modified zones module 235 and modified routes module 240. The modified zones module 235 and modified routes module 240 may be the same as zones module 215 and routes module 220, separate instances of zones module 215 and routes module 220, or unique modules compared to those of zones module 215 and routes module 220. The modified zones module 235 and modified routes module 240 may allow the user to adjust, modify or update parameters or data associated with specific zones. New scenarios may be generated based on existing scenarios by making changes to parameters and data associated with the existing scenario. Modified routes module 240 may also include modified impedance module 243. The modified impedance module 243 may determine route timings based on traffic flow, congestion, construction or other factors that slow the speed of vehicles or restrict a vehicle's access to a selected arrival point.

Train Module 250 may comprise simulated incidents module 255 and simulated notification module 260. The train module 250 may allow the user to create and/or modify incidents. The user may simulate an existing incident or scenario, an incident or modified scenario or a newly created incident or scenario.

The simulated incidents module 255 may comprise incident location module 256, incident type module 257 and affected zones module 258. Incident location module 256 may determine the location or epicenter of the incident. A user may enter an address or select a point or area on a map of the region to designate the incident location. Incident location module 256 may also determine the incident location based on randomly generated training data sets, historical incident data, or real-time data from external or internal sources. The incident type module 257 may allow the user to select an existing incident type, modify existing incident types or create new/custom incident types that are to be used in the simulation. The affected zones module 258 may determine the zones that are affected by the incident as time progresses. Based on the incident location, incident type, parameters of the incident and environmental data, the affected zones module 258 may estimate the population, number of structures and area for an evacuation recommendation. The zones in the path of the incident may then be determined by the affected zones module 258. In one particular, embodiment, the user modifies, or may only modify, simulated characteristics (as opposed to real, actual, measured characteristics being inputted, perhaps automatically).

Simulated notification module 260 may comprise authorization & audit trail module 261, stakeholders module 262 and social media module 263. Authorization & audit trail module 261 may keep a detailed record of user access, commands entered, incidents and notifications created, and modification of incidents or notifications. The authorization & audit trail module 261 may be used to authenticate users of the EPS 200 as well as verify their permission/authorization before a notification may be sent through selected communications channels. Stakeholders module 262 may establish a communication channel between EPC 101, EPS 102 and/or ANS 103 and police departments, fire departments and/or emergency service agencies. Social media module 263 may allow for the system to select from a list of social media platforms and applications. The social media module 263 may then establish a communication channel with the one or more social media platforms and applications and post authorized notifications and alerts to the platforms or applications.

Live module 270 may comprise real-time incidents module 275, real-time notification module 280 real-time data feeds module 285 and incident audit module 290. Live module 270 may perform the same functions as train module 250, but with real-time data feeds of real life incidents. Real-time data feeds module 285 may connect to external sources to ingest or aggregate real-time data from real life incidents, weather reports, evacuation statuses, occupancy/populations of zones, traffic, road closures, other events that impact impedance or combination thereof. Real-time incidents module 275 and real-time notification module 280 may be the same as simulated incidents module 255 and simulated notification module 260, separate instances of simulated incidents module 255 and simulated notification module 260, or unique modules compared to those of zones module 215 and routes module 220. Incident audit module 290 may record user activity while operating within the EPS 200. A record may include information relating to the identity of the user creating, modifying, accessing or interacting with an incident. The record may also include a list of all commands or interactions of the user and timestamps of each, so as to allow an audit to be performed at a later time.

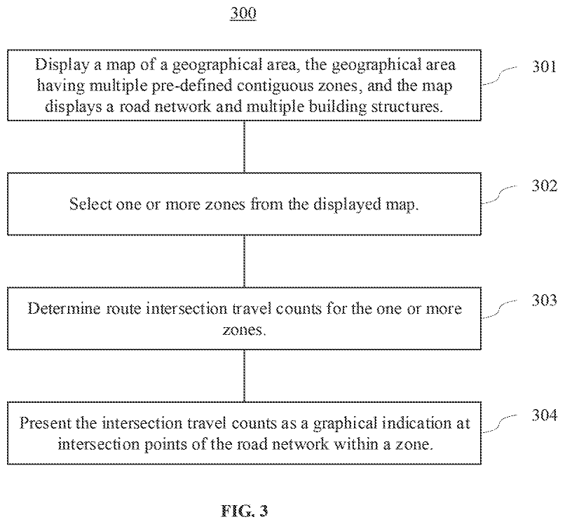

FIG. 3 shows an example of an overview of a process for displaying intersection travel counts of an evacuation plan for a selected zone in accordance with aspects of the present disclosure. Zones may be defined by a geographic boundary and thought of as units of public safety. They share common attributes such as demographics, ease of evacuation and geography. Zones are defined so that they do not cross each other. They may be defined with relation to roads, tessellated fabric, closed containers and/or other definitions of enclosed areas.

At step 301, the interface displays a map of a geographical area, the geographical area having multiple predefined contiguous zones, and the map displays a road network and multiple building structures. The map may also display no building structures, only selected building structures, structures of importance (i.e. hospitals, schools, police stations, fire stations, arenas, event centers, hotels, daycare facilities, assisted living facilities and any other highly populated structures or emergency response facilities.). The building structures may be displayed as icons, overhead outlines of the structures or combinations thereof.

At step 302, the user may select one or more zones from the displayed map. The zones may be separated by one or more zones, adjacent to one another or a combination thereof. Each zone may have key information associated with it, status or condition information of the zone and public agencies with jurisdiction over the zone. Public agencies (i.e. police, fire, supporting agencies, emergency response, or other secondary and tertiary agencies) may have jurisdiction over a portion of a zone, the entire zone or may span regions that overlap with multiple zones. Zones module 215 may make a determination, based off of the selected zones, as to which agency is assigned lead responsibilities for a given zone. Zones module 215 may also access information regarding the number of structures or address points, acreage of parcels, boundaries of properties and populations of the zone during different times of the day or night. Population module 217 may then estimate, based on the zones, time of day, events taking place, occupancy of hotels and hospitals, attendance at schools, commuting population, occupancy at retail locations or combination thereof.

At step 303, intersect counts module 222 may determine route intersection travel counts for the one or more zones. The determination may be based partly on the number of addresses a zone may have, which loosely correlates to the number of residential vehicles within a zone. The determination may also be based on the estimates from the population module 217. The intersect travel counts at each intersection correlates to the number of vehicles that pass through the intersection. When multiple vehicles take a route to an egress or arrival points from their respective residences or building structures, the vehicles from structures between intersections along the route are added to the intersection travel counts. As the path continues to the egress/arrival point, the intersection travel counts will increase. The interface may provide the user with a slide bar to modify a vehicle multiplier. The vehicle multiplier may be used to adjust the estimated number of vehicles within a zone. The multiplier may be applied to individual structures, a category of structures, structures in selected areas or combination thereof. For example, a user may wish to add a multiplier to residential structures over a certain size to take into consideration larger family sizes and the likelihood that a family of five is more likely to have more than one car than a single person living in a studio apartment. The multiplier may also be added by typing a number instead of moving a slide bar to input the desired adjustment. The interface may also allow for the multiplier to be entered proximate to individual selected building structures, and display on the map, the individual multipliers for all adjusted building structures. The interface may also allow for the user to reset all the multipliers entered, or selectively remove a multiplier from individual business structures.

At step 304, the interface may present the intersection travel counts as a graphical indication at intersection points of the road network within a zone. The graphical indication may visually represent the count by correlating the size or color of the indicator with the corresponding intersections intersect travel counts. For example, as the intersect travel counts increase, the size of the indicator may become larger, change color from a first color, representing a smaller number of vehicles, to a second color, representing a larger number of vehicles or a combination thereof. The color scale for the graphical indication may be discrete or continuous. When a discrete color scale is used, ranges of vehicle number values may be assigned to discrete colors. For example 1-50 may be assigned a blue color, 51-100 may be assigned a yellow color, 101-150 may be assigned an orange color and 151+ may be assigned a red color. The number ranges may be manually entered or automatically be generated based on the estimated number of vehicles in the selected zones. The same discrete representation can be used with regard to the size of the indicator as well. When a continuous color scale is used, the generated color of each individual indicator may be calculated based on the starting color, the ending color, and the estimated number of vehicles in the zones. Similarly, the size of the indicator may be calculated based on the minimum size of the indicator, the maximum size of the indicator, and the estimated number of vehicles in the zones. The indications may use a combination of the above visualization techniques when presenting the intersect travel counts on the map.

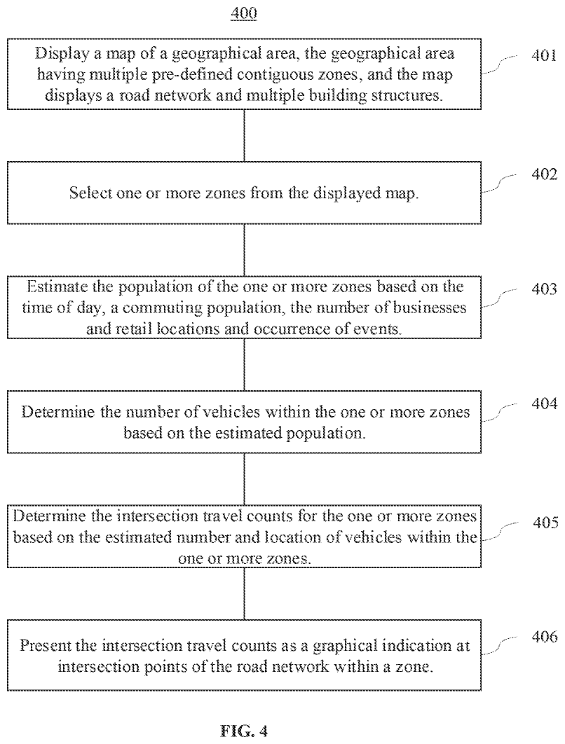

FIG. 4 shows an example of an overview of a process for displaying intersection travel counts of an evacuation plan for a selected zone in accordance with aspects of the present disclosure.

Steps 401, 402 and 406 are substantially similar to that of steps 301, 302 and 304 of FIG. 3 and will not be restated for sake of brevity.

At step 403, the population module 217 estimates the population of the one or more zones based on the time of day, a commuting population, the number of businesses and retail locations and occurrence of events. The population estimate may also take into consideration occupancy of hotels and hospitals, attendance at schools, occupancy at retail locations or combination thereof.

At step 404, intersect counts module 22 may determine the number of vehicles within the one or more zones based on the estimated population. The determination may also be based partly on the number of addresses a zone may have, which loosely correlates to the number of residential vehicles within a zone. Also, a vehicle multiplier may be used to adjust the estimated number of vehicles within a zone. The determination may take into account a vehicle multiplier applied to individual structures, a category of structures, structures in selected areas or combination thereof.

At step 405, intersect counts module 222 may determine the intersection travel counts for the one or more zones based on the estimated number and location of vehicles within the one or more zones. The determination may take into consideration the routes generated by the egress module 221 to predict the path that each vehicle will take and calculating the intersection travel counts for each intersection along the egress routes.

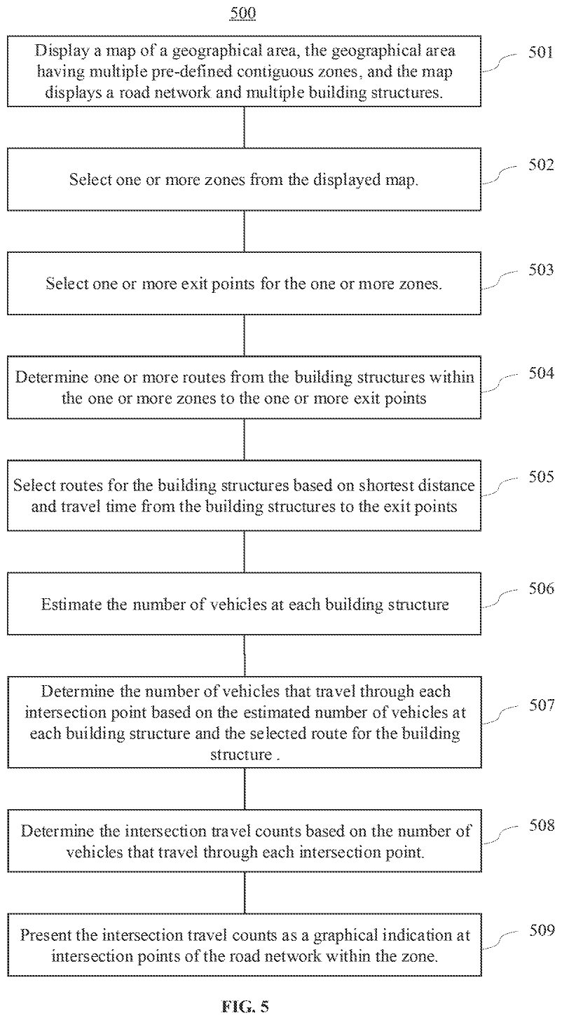

FIG. 5 shows an example of an overview of a process for displaying intersection travel counts of an evacuation plan for a selected zone in accordance with aspects of the present disclosure.

Steps 501, 502 and 509 are substantially similar to that of steps 301, 302 and 304 of FIG. 3 and steps 401, 402 and 406 of FIG. 4 and will not be restated for sake of brevity.

At step 503, the user may select one or more exit points for the one or more zones. The selection of the exit points may include, e.g., major highway intersections, onramps, arrival points, safe havens, bunkers, shelters, schools, temporary refuge areas, temporary staging areas, event centers, transportation hubs or other evacuation facilities. Major highway intersections may be used as the initial/default exit points.

At step 504, the routes module 220 and/or the egress module 221 may determine one or more routes from the building structures within the one or more zones to the one or more exit points.

At step 505, the system selects routes for the building structures based on shortest distance and travel time from the building structures to the exit points.

At step 506, population module 217 may estimate the number of vehicles at each building structure. The estimate may be sent to the routes module 220 and/or the intersect counts module 222.

At step 507, the intersect counts module 222 may determine the number of vehicles that travel through each intersection point based on the estimated number of vehicles at each building structure and the selected route for the building structure.

At step 508, the intersect counts module 222 may determine the intersection travel counts based on the number of vehicles that travel through each intersection point.

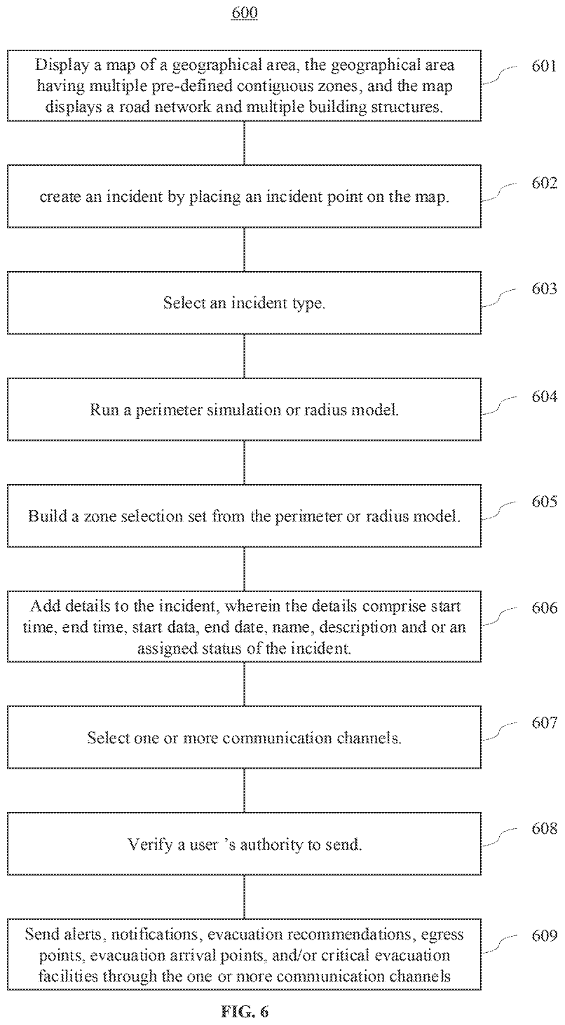

FIG. 6 shows an example of an overview of a process for alerting residence of an emergency and providing an evacuation plan for effected zones in accordance with aspects of the present disclosure.

At step 601, the interface displays a map of a geographical area, the geographical area having multiple predefined contiguous zones, and the map displays a road network and multiple building structures.

At step 602, the user may choose to create an incident by placing an incident point on the map. The user may also select an incident area or may enter an address for the location of the incident. The user may also select or enter a radius of impact of the incident, and/or a movement/spread speed and direction of the incident.

At step 603, the user may select an incident type. The type of incident may be chosen from a list or entered as text. A user may also create a custom incident, including the combining of multiple existing incidents into a new incident. Incident types may include, but are not limited to, fire scenario over multiple zones, earthquake, floods, tsunami, nuclear fallout, terrorist attacks, hazardous materials, dam inundation, coastal inundation, active shooter, bomb threat, pandemic (i.e. Covid-19). The incident may also be hazard agnostic.

At step 604, the system may run a perimeter simulation or radius model to determine the areas of impact as the incident unfolds. For example, when a fire incident is created, the model may predict the path the fire will take, the area that will be affected and the speed of the spread.

At step 605, the system may build a zone selection set from the perimeter simulation or radius model.

At step 606, the user may add details to the incident, wherein the details comprise start time, end time, start data, end date, name, description and or an assigned status of the incident.

At step 607, the user may select one or more communication channels. Communication channels may include social media, location-based phone apps, direct communication with local, state and federal agencies, and other stakeholders from the community affected.

At step 608, the system may verify a user's authority to send before allowing any information relating to the incident to be disseminated.

At step 609, the system sends alerts, notifications, evacuation recommendations, egress points, evacuation arrival points, and/or locations of critical evacuation facilities through the one or more communication channels.

Relatedly, in some examples, the system may generate an evacuation pre-plan for one or more predefined zones. For instance, in some examples, an evacuation pre-plan may be for one of the predefined zones, which may be selected by the user via the user interface. In some examples, the evacuation pre-plan may be based at least in part on data entered by a user or retrieved from a datastore, special conditions, critical evacuation facilities, traffic control points and resources. In some examples, the system may generate, based on least in part on the evacuation pre-plan, one or more reports depicted routes, structures, exit points that were predefined for the particular pre-defined zones.

In some examples, the system may also perform the operation of triggering one or more actions based on an actual or simulated incident, such as where the perimeter of the incident may move about one or more predefined zones. Some examples of the system or methods described herein may also include the operation of providing an application programming interface having a function for allowing requests of information related to a particular zone-based on a received zone identifier. Some examples may also include providing a response including one or more of a count value. The count value may be, e.g., for an estimated day population, an estimated night population, an estimated number of vehicles located in the zone during a day time period, an estimated number of vehicles located in the zone during a night period, a number of structures or address points, an array of geo-locations of traffic control points, an array of geo-locations of arrival points, and an array of zone routes.

Some examples of the system and/or method described herein may also include, or perform the operation of providing, an application programming interface. Some embodiments of the application programming interface may have a function for generating a listing of zone identifiers for those zones that are associated with, e.g., a county identifier, city identifier, other geo-spatial identifier, or geographic area. Some examples may also include displaying different incident types for selection. For example, the incident types may include one or more of a fire, flood, active shooter, hazardous material, or dam inundation. Some examples may also include receiving a selection of the incident type, a text input describing the incident, and a time value for the incident. Some examples may also include receiving a location for the occurrence of the incident. Some examples may also include creating a training incident simulation based on the selected incident type and location for the occurrence of the incident. Some examples may also include simulating the training incident via the user interface. One or more of such operations may be performed via the user interface. For example, in some examples, the training incident may be displayed via the interface as occurring in one or more predefined zones near the received location.

Relatedly, some examples may include displaying, via the user interface, different communication channels for selection. Some examples may also include receiving a selection of one or more communication channels. Some examples may also include assigning the selected communication channels for distribution of information associated with the training incident. Some examples may also include displaying, via the user interface, a group of the predetermined zones to a first group of one or more users. Some examples may also include displaying zone attributes to the first group of one or more users. In some embodiments, the users may have similar viewing privileges. In some embodiments, the zone attributes may include, e.g., traffic control points, evacuation arrival points and/or evacuation routes. Some examples may also include displaying, via the user interface, the group of predetermined zones to a second group of one or more users. Some examples may also include not displaying the zone attributes to the second group of one or more users.

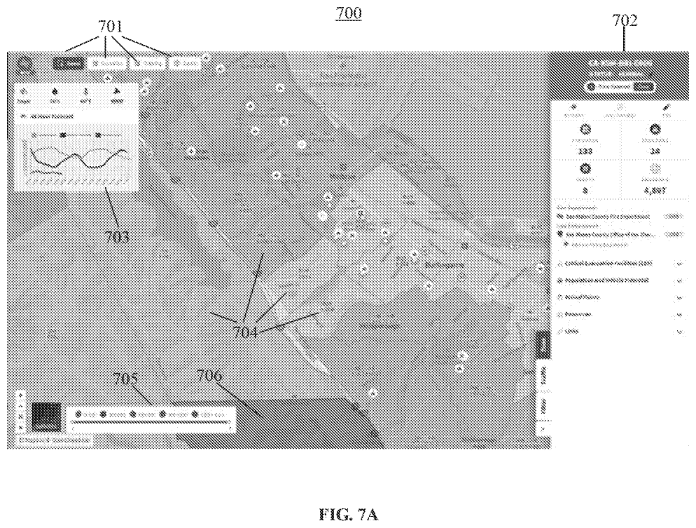

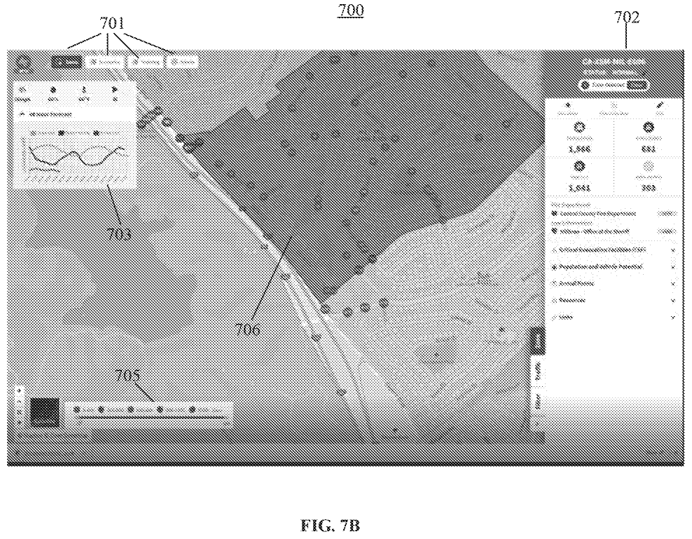

FIGS. 7A-7B shows an example of an EPS interface 700 in accordance with aspects of the present disclosure. EPS interface 700 may comprise mode selection icons 701, zone status and information 702, environmental information window 703, geographic zones 704, map key 705 and selected zone 706.

Mode selection icons 701 may be used to select the mode of operation. The user may select zones, scenarios, training, admin, live or additional modes of operation. Zone status and information 702 may display the current status of the one or more selected zones. An option for the user to clear the selections may be provided to the user. A list of the zones currently selected, including acronyms for counties and unique identifiers for the zone, may be displayed. The zone status and information 702 pane may also include population, structures, parcels, area, fire and police departments with jurisdiction within the zone, critical evacuation facilities (CEF), population and vehicle potential, arrival points, evacuation resources, community resources, traffic control points, routes and links. An environmental information window 703 may display current hyper-local weather reports as well as weather forecasts. The map is divided into geographic zones 704, which do not overlap each other. The user may be allowed to select one or more geographic zones 704 from the map. The map key 705 provides an explanation of the symbols and colors used in the map. Map key 705 may provide the count ranges and colors for the intersection points displayed in the map. The slider bar may allow for filtering the map display by adding or removing intersection points based on the count number. When the user selects a zone, such as selected zone 706, the selected zones may be differentiated from non-selected zones by a visual indication such as highlighting, outlining or other distinguishable visual characteristics. Selected zone 706 may also display an indication of the intersection counts.

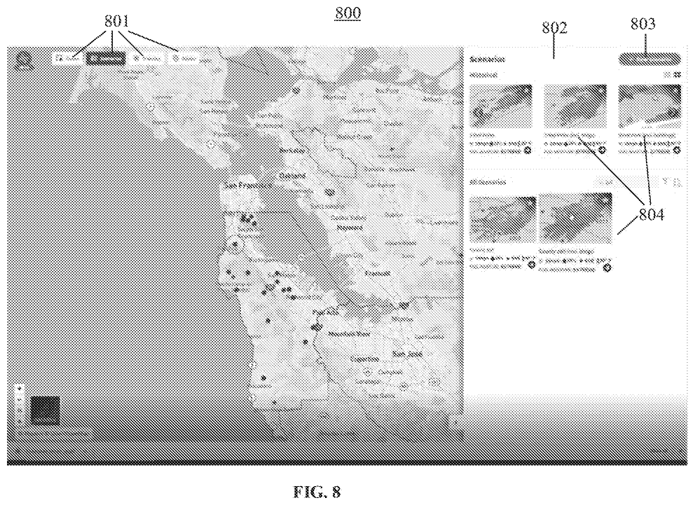

FIG. 8 shows an example an EPS interface 800 in accordance with aspects of the present disclosure. EPS interface 800 may comprise mode selection icons 801, scenarios pane 802, new scenario selection 803 and existing scenario selection 804.

Mode selection icons 801 may be used to select the mode of operation. The user may select zones, scenarios, training, admin or live. Scenarios pane 802 may include a selection options such as a new scenario selection 803 and existing scenario selection 804.

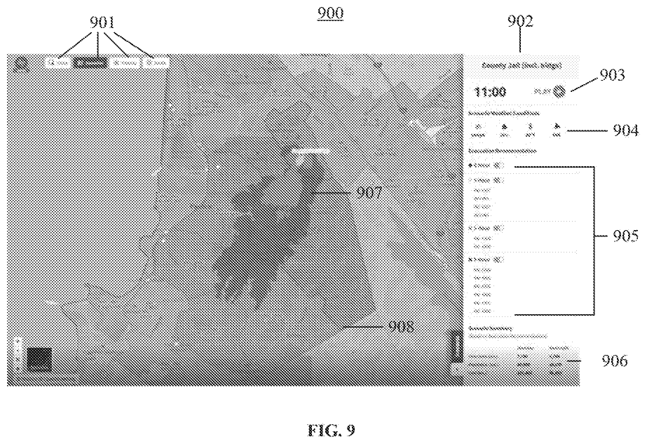

FIG. 9 shows an example an EPS interface 900 in accordance with aspects of the present disclosure. EPS interface 900 may comprise mode selection icons 901, scenario information pane 902, incident impact area 907 and the set of zones affected by the impact area 908.

Mode selection icons 901 may be used to select the mode of operation. The user may select zones, scenarios, training, admin or live. Scenario information pane 902 may include a play scenario button 903, scenario weather conditions 904, scenario evacuation recommendations by zone 905 and scenario summary 906. The play scenario button 903 may be selected to cause a time based visualization/animation of the incident to be displayed over the map. Scenario weather conditions 904 may provide information such as wind speed, precipitation, wind speed and direction, temperature, and humidity. Other weather conditions may be displayed as well. Recommendations for zones to be evacuated and the times at which each zone should be evacuated may be displayed in the scenario evacuation recommendations 905 section. The times at which each zone is evacuated may be based on the rate of spread of the simulated incident, such as a simulated fire spread, flood simulations or hazardous plumes simulations. A scenario summary 906 may be displayed for the selected zones and scenario. The scenario summary 906 may include the estimated number of structures or address points, population and vehicles in the evacuation zone. The scenario summary 906 may also include the estimated number of structures or address points, population and vehicles in the evacuation zone at different times (i.e. weekday, weeknight, weekend day, weekend night or any time in between.). The incident impact area 907 may visually indicate the affected areas of the map. The incident impact area 907 may visually differentiate the time based progression or spread of the impacted area. To visually differentiate the spread of the incident, different colors or shading may be used for the regions affected at corresponding times.

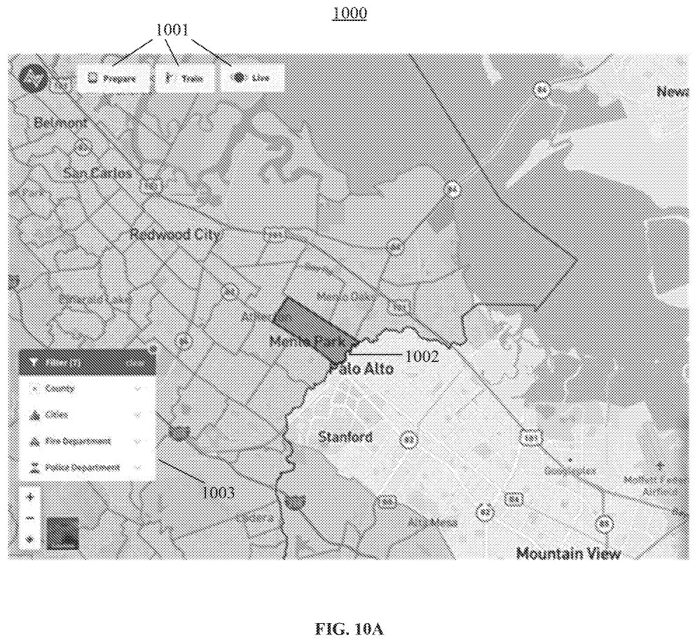

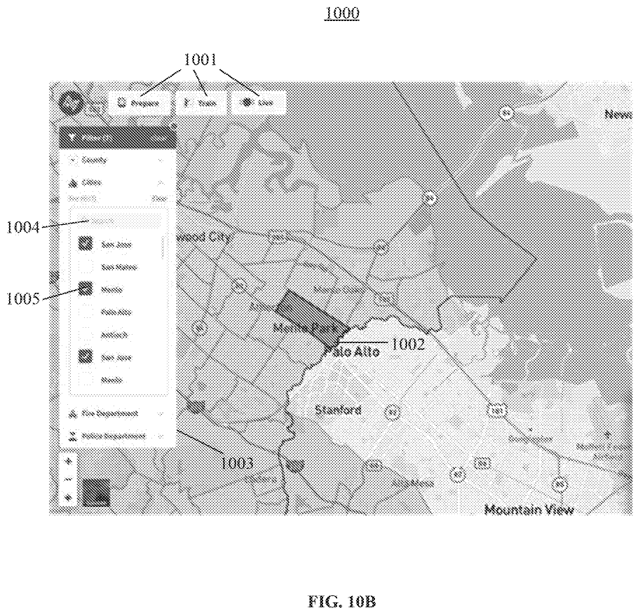

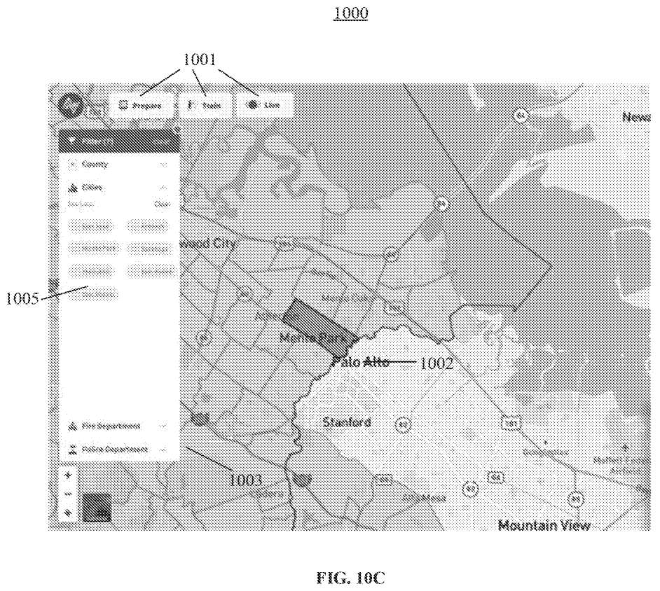

FIGS. 10A-10C shows an example of a filter option in an EPS interface I 000 in accordance with aspects of the present disclosure. EPS interface 1000 may comprise mode selection icons 1001, selected zone 1002, filter option pane 1003, filter option search 1004 and filter selection 1005. The user may select one or more zones from the map by clicking/touching the map within the borders of the respective one or more zones. The user may also select multiple zones by clicking/touching and dragging the selection over the zones that they wish to select, much like a highlighter, or drawing a polygon around the zones that they wish to select. The filter option pane 1003 may be used by the user to filter out or add counties, cities, fire departments, police departments or other agencies or categories to the selected zone 1002.

In FIG. 10B the filter option pane 1003 may be expanded upon the selection of a filter category. The expanded category may provide the user with an option search 1004 field and filter selection 1005. The user may type the name or partial name of an entry that they wish to add or remove into the option search 1004. The option search 1004 would then display only the entries that match the search criteria. The user may also scroll the entire list of entries in the filter selection 1005 pane. The filter selection 1005 pane may display all entries with the selected entries indicated as is shown in FIG. 10B. The filter selection 1005 pane may alternatively only display the selected entries as is shown in FIG. 10C. The user may deselect the selected entries by clicking a delete, trash bin, or ‘X’ icon or link associated with the selected entry as is shown in FIG. 10C. With regards to FIG. 10B, the user may uncheck the box associated with the entry selection.

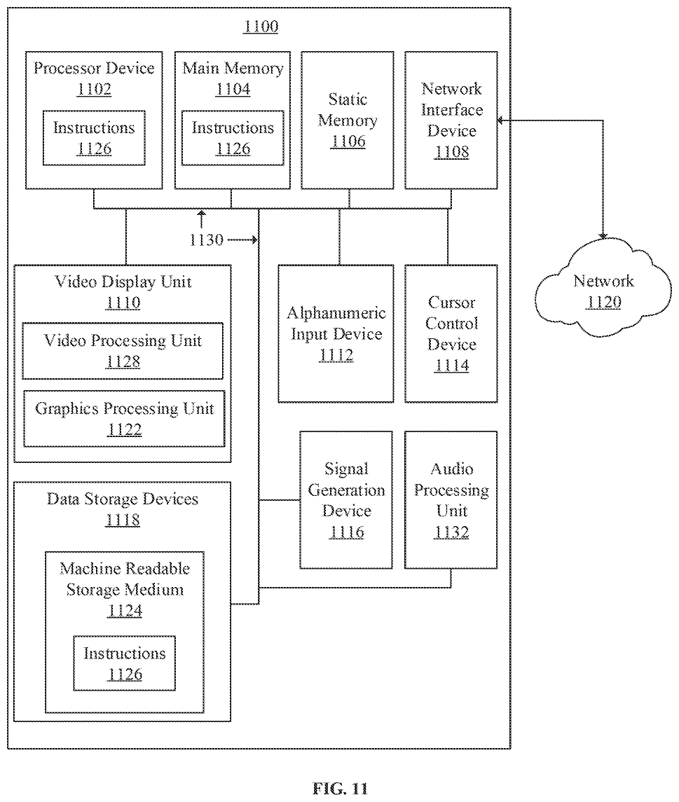

FIG. 11 illustrates an example machine of a computer system within which a set of instructions, for causing the machine to perform any one or more of the methodologies discussed herein, may be executed. In alternative implementations, the machine may be connected (e.g., networked) to other machines in a LAN, an intranet, an extranet, and/or the Internet. The machine may operate in the capacity of a server or a client machine in client-server network environment, as a peer machine in a peer-to-peer (or distributed) network environment, or as a server or a client machine in a cloud computing infrastructure or environment.

The machine may be a personal computer (PC), a tablet PC, a set-top box (STB), a Personal Digital Assistant (PDA), a cellular telephone, a handheld tablet device, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1100 includes a processing device 1102, a main memory 1104 (e.g., read-only memory (ROM), flash memory, dynamic random access memory (DRAM) such as synchronous DRAM (SDRAM) or Rambus DRAM (RDRAM), etc.), a static memory 1106 (e.g., flash memory, static random access memory (SRAM), etc.), and a data storage device 1118, which communicate with each other via a bus 1130.

Processing device 1102 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 1102 may also be one or more special-purpose processing devices such as an application specific integrated circuit (ASIC), a field programmable gate array (FPGA), a digital signal processor (DSP), network processor, or the like. The processing device 1102 is configured to execute instructions 1126 for performing the operations and steps discussed herein.

The computer system 1100 may further include a network interface device 1108 to communicate over the network 1120. The computer system 1100 also may include a video display unit 1110 (e.g., a liquid crystal display (LCD) or a cathode ray tube (CRT)), an alphanumeric input device 1112 (e.g., a keyboard), a cursor control device 1114 (e.g., a mouse), a graphics processing unit 1122, a signal generation device 1116 (e.g., a speaker), graphics processing unit 1122, video processing unit 1128, and audio processing unit 1132.

The data storage device 1118 may include a machine-readable storage medium 1124 (also known as a computer-readable medium) on which is stored one or more sets of instructions or software 1126 embodying any one or more of the methodologies or functions described herein. The instructions 1126 may also reside, completely or at least partially, within the main memory 1104 and/or within the processing device 1102 during execution thereof by the computer system 1100, the main memory 1104 and the processing device 1102 also constituting machine-readable storage media.

In one implementation, the instructions 1126 include instructions to implement functionality corresponding to the components of a device to perform the disclosure herein. While the machine-readable storage medium 1124 is shown in an example implementation to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media and magnetic media.

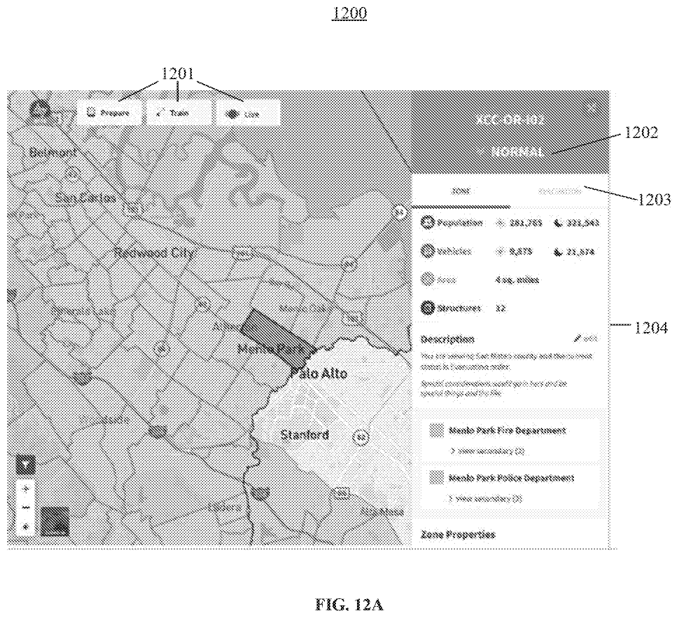

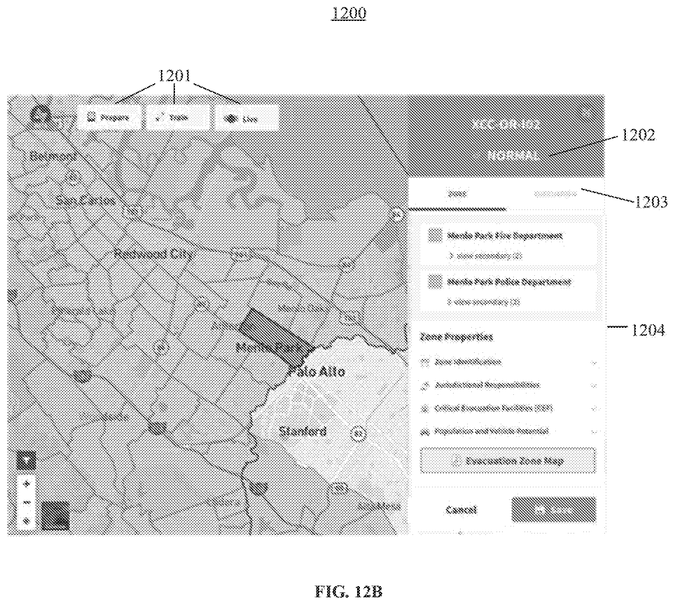

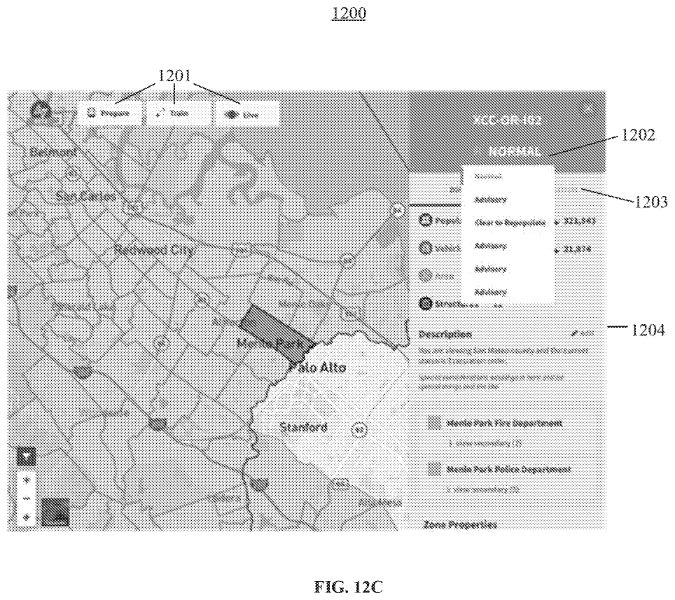

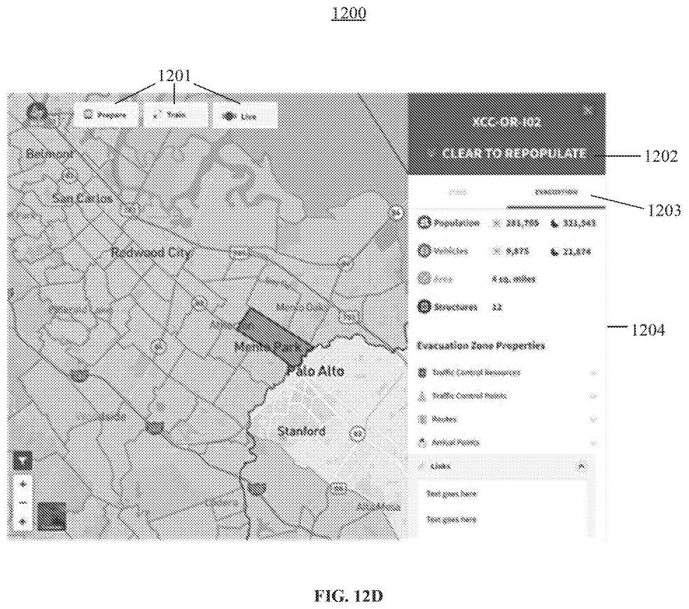

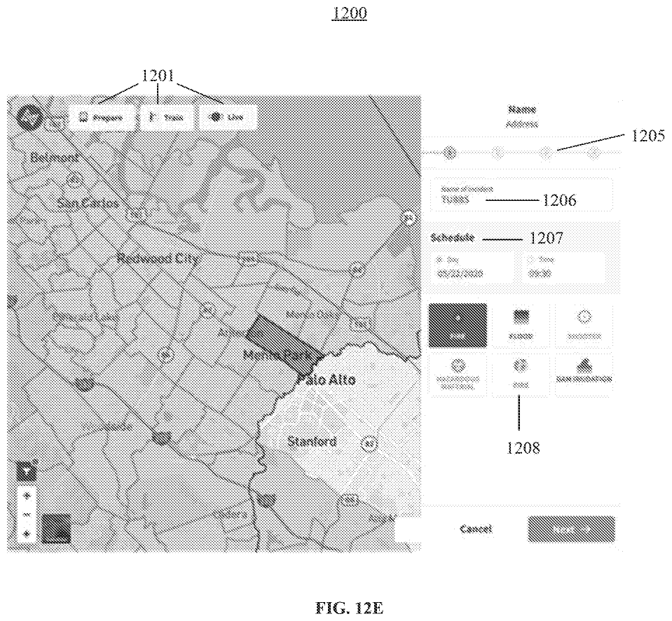

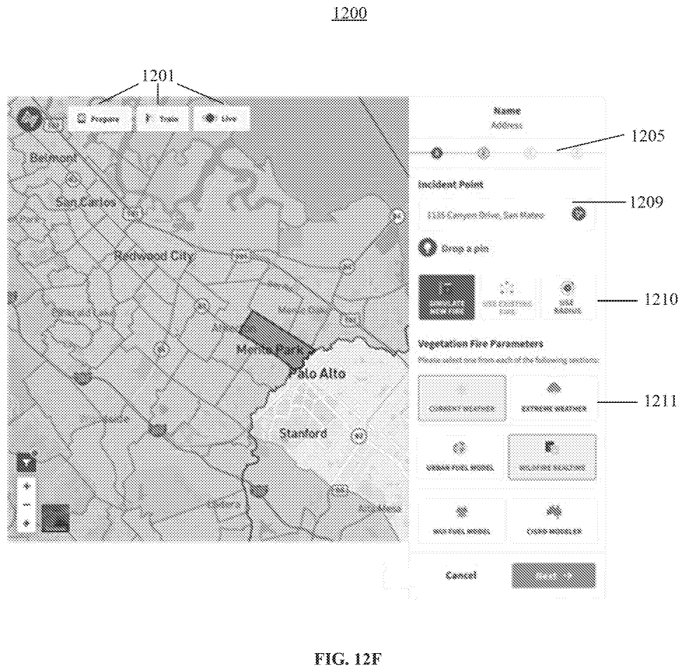

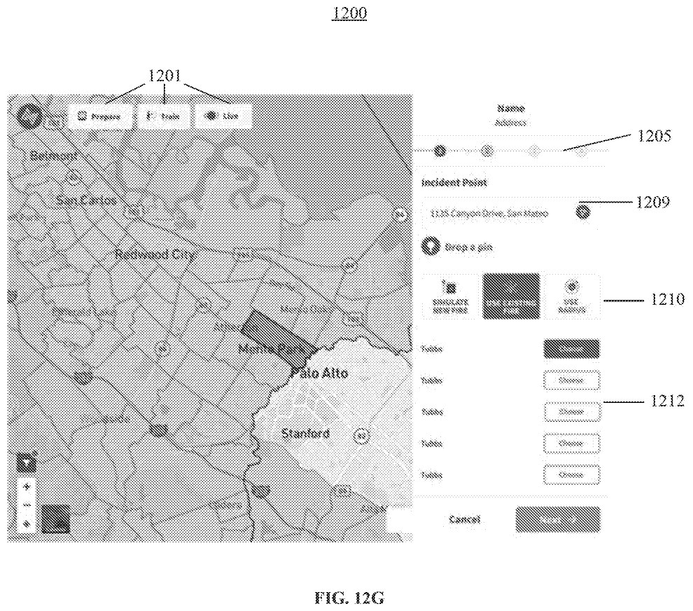

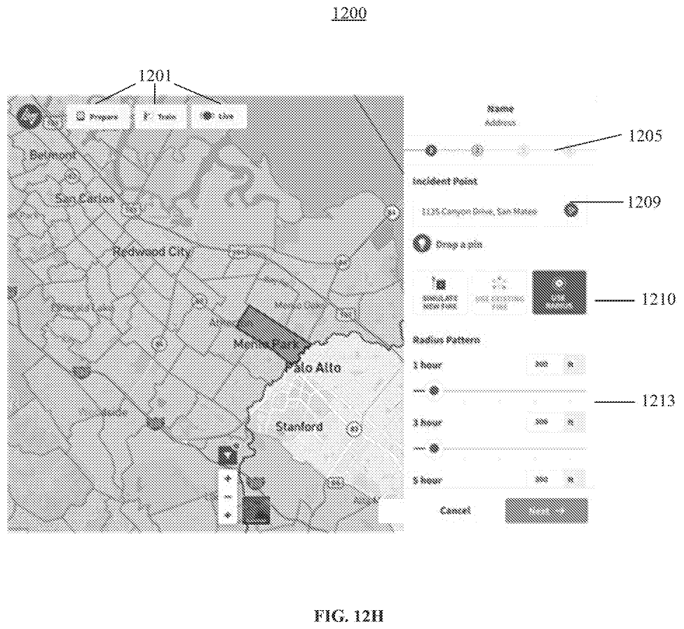

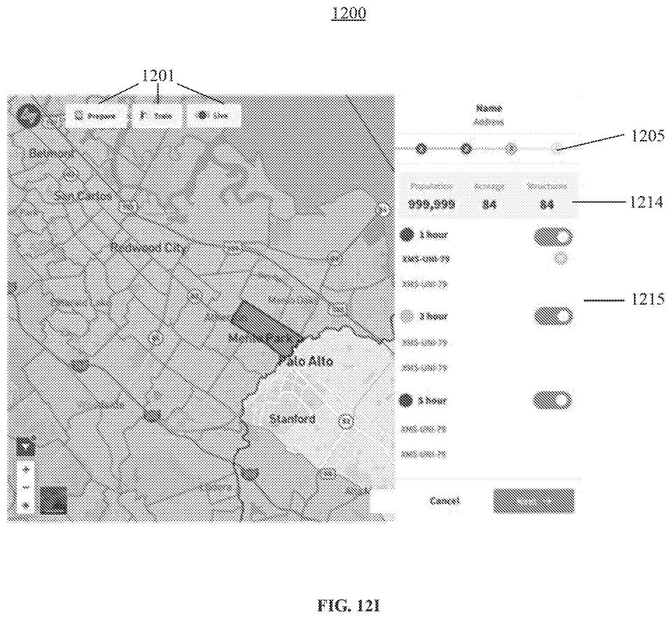

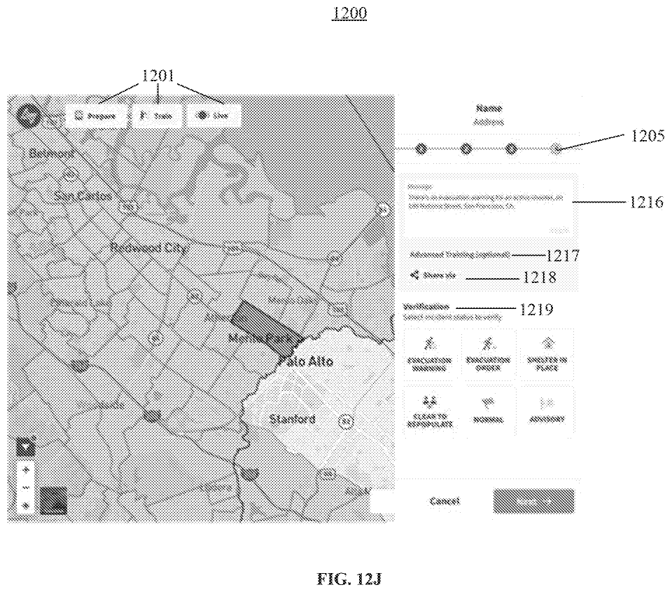

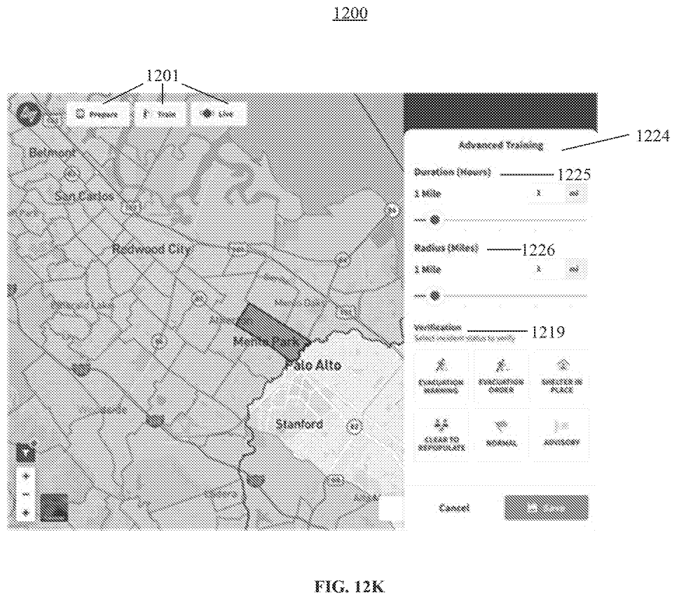

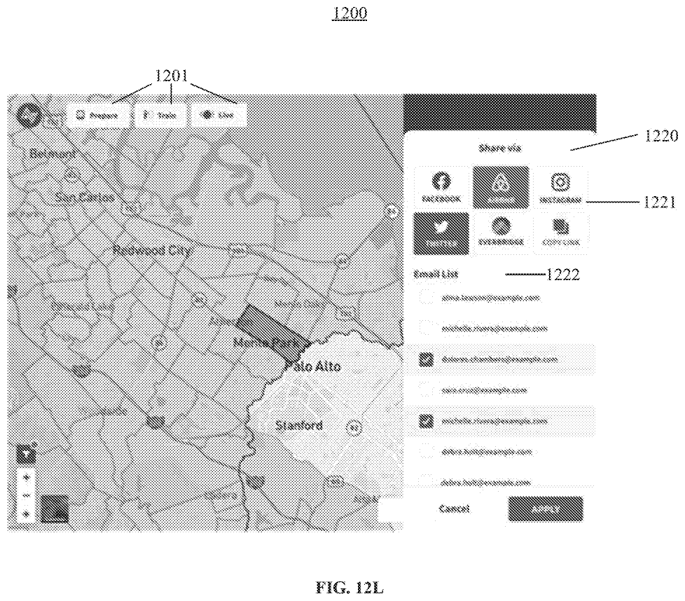

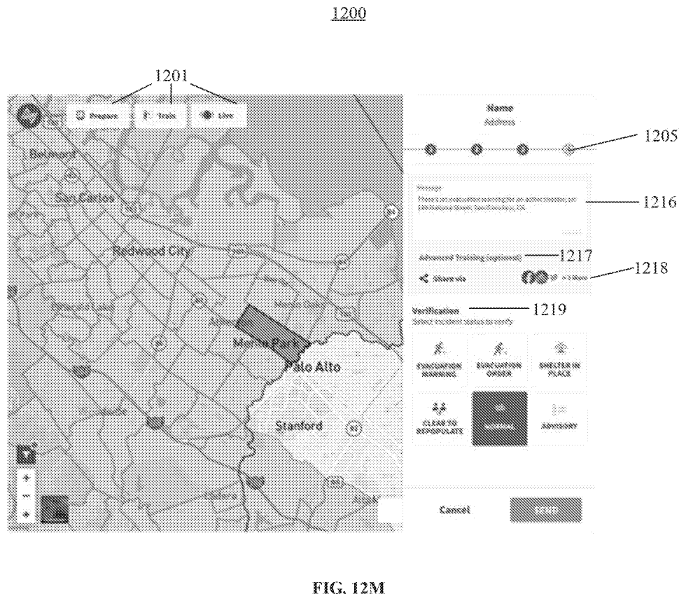

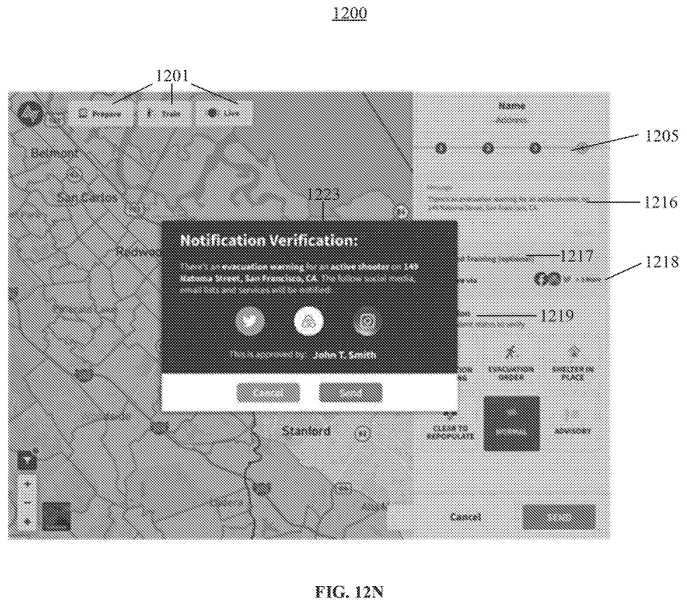

FIGS. 12A-12N show an example interface of a multi-hazard spatio-temporal zone-based evacuation management platform in accordance with aspects of the present disclosure.

FIGS. 12A-12C show an embodiment of the EPS 102 user interface 1200. The user may select an operating mode by using the mode selection icons 1201. Modes may include a preparation mode, a training mode, a live mode, a scenario mode or additional modes that are customized by the user, exist within the platform already or retrieved from external applications or databases. The user interface 1200 may also display a zone status, selection tabs 1203 and an information pane 1204. The zone status 1202 may also be a used as a selection of the status of the one or more selected zones. For example, the user may select the zone status 1202, and given a list of statuses that may be chosen from. The list may include normal, advisory, clear to repopulate, and other statuses related to incidents occurring within the zone. The list may be dynamically generated with statuses that are relevant to the type of incident and the zones that are selected. The list may also be prepopulated with default statuses. A user may also be allowed to create, edit, or import statuses that are to be used in the zone status 1202 list. The selection tabs 1203 may be used to view different types of information relating to the selected zones. When the zone tab is selected, information about the one or more selected zones may be displayed. The information may include day and night populations, day and night vehicle numbers, area (acres or hectares), number of structures or address points, description of the zones, police and fire departments with jurisdiction over the one of more zones, zone properties and/or evacuation zone maps or links to the evacuation zone maps.

In response to the user selection of one or more zones in the user interface 1200, the system 100 will summarize or aggregate counts for information associated with the selected zones. For example, the user interface may present a population count, a vehicle count, total area, and the number of structures or address points located in the selected zones. For the population and vehicle counts, the user interface may display a count for day and for night time periods. For example, the day period may be from 7 a.m. to 8 p.m., and the night period may be from 8 p.m. to 7 a.m. The counts may be displayed for these different time period to indicate the estimated persons and vehicles that are located within the selected zones.

FIGS. 12D-12N shows an embodiment of the EPS 102 user interface 1200 in which a user may create a new incident. As shown in FIG. 12D, the user may select “REPOPULATE” or other appropriate statuses from the zone status 1202 to begin the creation of a new incident. Selection of the “EVACUATION” tab from the selection tabs 1203 may cause the interface to display zone details and/or zone information relating to an evacuation. The information may include day and night populations, day and night vehicle numbers, area (acres or hectares), number of structures or address points, evacuation zone properties and links related to the evacuation of the selected one or more zones.

In FIG. 12E, a creation progress indicator 1205 may be displayed to show the user their current progress in the creation of the incident. The creation progress indicator 1205 may be a linear representation of the steps required to complete the incident creation. This linear representation may be used for tracking the progress of the incident creation as well as provide clickable navigation to individual steps of the process. The user may enter a name into the incident name 1206 field to identify the incident. Incident scheduling 1207 may allow the user to enter the date and time of the incident. The user may input the date and time numerically or select the date and time from a selection window or calendar. A user may then make a selection of a type of incident from the incident type selection 1208. The incident type may be selected before or after any other information is entered within this pane. Selections and user entries may be taken out of order during the creation of the incident. Incident types may include fire, flood, shooter, hazardous material, dam inundation, coastal inundation, bomb threat, pandemic, earthquakes, tsunamis, nuclear fallout, terrorist attacks or combination thereof. Addition incident types may be added or created. The incident type may also include selectable subtypes.

FIG. 12F shows an example of a fire incident being created. When a user selects a fire incident from the incident type selection 1208 of FIG. 12E, the interface may display options and information related to the fire type incident. Creation progress indicator 1205 may increment or display a visual indication that the creation process is proceeding to the next step. A user may enter an address of the incident at incident location 1209. The user may also drop a pin on the map or select a region on the map to define the incident location 1209. Incident model selection 1210 may provide different incident modeling options to the user. The user may choose between creating a new simulation, using existing simulations, or using a radius model in the simulation. A list of incident model properties may also be displayed at the incident parameter selection 1211. The incident parameter selection 1211 pane may list the same or different parameters for each type of incident. For example, for a fire incident in which the user selects the “SIMULATE NEW FIRE” from the incident model selection 1210, the incident parameter selection 1211 may include current weather, extreme weather, urban fuel model, wildfire real-time model, other models as well as other vegetative fire parameters. The user may select one or more of these incident parameters to be considered in the model of the incident.

FIG. 12G shows an example of a user selecting “USE EXISTING FIRE” from the incident model selection 1210. Upon selection of “USE EXISTING FIRE,” a list of existing models may be provided to the user in the existing model selection 1212. The user may select on more of the existing models in the creation of the incident.

FIG. 12H shows an example of a user selecting “USE RADIUS” from the incident model selection 1210. Upon selection of “USE RADIUS,” a user may enter parameters in the radius model parameter selection 1213. These parameters may include radius patterns at different time intervals.

FIG. 12I shows an example of the interface displaying the zones affected by the incident based on the incident model used. Impacted zone information 1214 may be displayed along with the time based zone impaction 1215 information. The impact zone information 1214 may include population, acreage, structures and any other information related to the zone affected. The time based zone impaction 1215 pane may allow the user to toggle or otherwise turn off the displaying or modeling of each time step. The user may also remove individual zones from the timesteps, add zones to the time steps and create additional timesteps.

In FIG. 12J the user may enter information relating to the incident in the incident message 1216 section. The incident message 1216 may also be a predetermined message. Predetermined messages may be based on agency, incident type, evacuation status, simulation results or received real-time information. At this stage, the user may select advanced training 1217 in order to enter additional parameters pertaining to the created incident and the incident model. The user may choose one or more communications channels to notify or alert by selecting the share via option 1218. Before the incident creation can be completed, the user may need to select an incident status from incident verification 1219 to verify that the incident created is correct.

The user may be presented with the advanced training options pane 1224 of FIG. 12K upon selection of the advanced training 1217 option of FIG. 12J. The advanced training options panel 224 may include an advanced training duration selection 1225 and an advanced training radius selection 1226.

FIG. 12L shows the incident sharing options 1220 that are displayed as a result of selecting the share via option 1218. The incident sharing options 1220 may include a communication channel selection 1221 and a contact list 1222. The communication channel selection 1221 may allow the user to select one or more social media channels to send incident information and alerts to. The contact list 1222, may also allow the user to select multiple contacts to send the incident alerts and information to. The contacts may be listed by name, email, agency name, phone number or other group designations. For example, the communication channels may include communication via Facebook, AirBNB, Instagram, Twitter, Everbridge and/or other social media platforms. Additionally, a link may be generated and copied where the link allows a user to click on the link and the link would display the incident details via the user interface. The user interface 1200 may also display for selection or input a list of users, persons and/or email addresses that should receive information relating to the incident.

FIG. 12M shows an example of the final stages of creating an incident. In this example the user has entered text into the incident message 1216 section, selected multiple communications channels via the share via option 1218, and selected the normal incident status in the incident verification 1219. The user may have also entered advanced training options. The user may then choose to send the incident by clicking the send button. The created incident may be saved as a result of selecting send, automatically saved upon selection of the incident verification 1219, or incrementally saved during each step of the incident creation.

FIG. 12N shows a notification verification prompt 1223 being displayed as a result of the user selecting send from FIG. 12M. The verification prompt 1223 may display the incident message 1216, communications channels and contacts that are to be notified and the person/user who approved the creation of the incident and the sending of the alert and notification.

While the above describes configuration for a simulated training incident, the user interface may be utilized for creating a response to a determined real-time or actual incident. For example, the user interface may also provide for the selection of the various incident types and provide a selection of communication channels and to which particular users would receive communications should a real-time or actual incident occur.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “identifying” or “determining” or “executing” or “performing” or “collecting” or “creating” or “sending” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage devices.

The present disclosure also relates to an apparatus for performing the operations herein. This apparatus may be specially constructed for the intended purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs,) random access memories (RAMs), EPROMs, EEPROMs, magnetic or optical cards, or any type of media suitable for storing electronic instructions, each coupled to a computer system bus.

Various general purpose systems may be used with programs in accordance with the teachings herein, or it may prove convenient to construct a more specialized apparatus to perform the method. The structure for a variety of these systems will appear as set forth in the description above. In addition, the present disclosure is not described with reference to any particular programming language. It will be appreciated that a variety of programming languages may be used to implement the teachings of the disclosure as described herein.

The present disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form readable by a machine (e.g., a computer). For example, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc.

In the foregoing disclosure, implementations of the disclosure have been described with reference to specific example implementations thereof. It will be evident that various modifications may be made thereto without departing from the broader spirit and scope of implementations of the disclosure as set forth in the following claims. The disclosure and drawings are, accordingly, to be regarded in an illustrative sense rather than a restrictive sense.

1. A system for zone-based evacuation management comprising one or more processors, and a non-transitory computer-readable medium including one or more sequences of instructions that, when executed by the one or more processors, cause the system to perform operations comprising:
displaying, via a user interface, a map of a geographical area, the geographical area having multiple predefined contiguous zones, wherein a zone defines an area of the map having geographic boundaries, wherein the map displays a road network and multiple building structures, and wherein the user interface is configured for receiving a selection of one or more of the predefined contiguous zones, and wherein the user interface is configured for modifying one or more attributes associated with a particular zone.

2. The system of claim 1, further comprising the operations of:
determining route intersection travel counts for one or more zones; and
displaying, via the user interface, the intersection travel counts as a graphical indication at intersection points of the road network within a zone.

3. The system of claim 2, wherein the route intersection travel counts are determined based at least in part on the number of structures or address points and number of vehicles residing at each structure or address point within the one or more zones and the intersection points which each vehicle travels through during an evacuation.

4. The system of claim 2, wherein the route intersection travel counts of intersections points increase as more vehicles are added between intersection points.

5. The system of claim 3, wherein the number of vehicles within the one or more zones are determined based at least in part on a time of day and an estimated population of the one or more zones at the time of day, wherein the estimated population is based at least in part on a commuting population, the number of businesses and retail locations within the one or more zones, events occurring within the one or more zones and the estimated number of attendees and/or the populations at facilities within the one or more zones.

6. The system of claim 2, further comprising the operations of:
receiving a selection by the user via the user interface of a zone or one or more structures within a zone;
receiving, via the user interface, a multiplier for the selected zone or structures; and
adjusting the number of vehicles residing at the selected zone or structures based at least in part on the received multiplier.

7. The system of claim 6, further comprising the operation of:
displaying, via the user interface, a slide bar associated with the route intersection travel counts for the selected zones;
receiving, via the user interface, an interaction with the slide bar; and
adjusting the displayed intersection travel counts based at least in part on the interaction with the slide bar.

8. The system of claim 1, wherein determining the route intersection travel counts further comprises:
selecting one or more exit points for the one or more zones;
determining one or more routes from the building structures within the one or more zones to the one or more exit points;
selecting routes for the building structures based at least in part on shortest distance and travel time from the building structures to the exit points;
estimating the number of vehicles at each building structure; and
determining the number of vehicles that travel through each intersection point based at least in part on the estimated number of vehicles at each building structure and the selected route for the building structure.

9. The system of claim 8, wherein the exit points are selected from a list comprising of:
major highway intersections or on-ramps;
designated safe haven facilities;
bunkers;
shelters;
transportation hubs;
schools;
temporary refuge areas;
temporary staging areas; and
event centers.

10. The system of claim 1, further comprising the operations of:
simulating the occurrence of a time-based incident occurring over one or more of the predefined contiguous zones.

11. The system of claim 10, the simulating the occurrence comprising the operations of:
creating, via the user interface, an incident, wherein the creating comprises:
placing an incident point on the map; selecting an incident type;
running a perimeter simulation or radius model;
building a zone selection set from the perimeter simulation or radius model;
adding details and/or retrieved predefined information to the incident, wherein the details comprise start time, end time, start data, end date, name, description and or an assigned status of the incident;
selecting one or more communication channels, wherein the channels compose stakeholders, social media and/or mobile applications;
verifying a user's authority to send; and
sending, through the one or more communication channels, alerts, notifications, evacuation recommendations, egress points, evacuation arrival points, and/or critical evacuation facilities.

12. The system of claim 1, further comprising the operations of:
determining the occurrence of a real-time incident, wherein the occurrence includes receiving geo-location information of the real-time incident; and
displaying via the user interface, based at least in part on the geo-location information, the occurrence of the real-time incident occurring over one or more of the predefined contiguous zones, the occurrence depicted as a graphical shape indicating the area of the real-time incident.

13. The system of claim 12, further comprising the operations of:
based at least in part on the determination of the occurrence of the real-time incident, providing alerts and notifications to particular users, wherein the users have been pre-configured to receive the alerts and notifications for the type of the incident and the zones in which the incident is occurring or is predicted to occur.

14. The system of claim 1, further comprising the operations of:
generating an evacuation pre-plan for one or more of the predefined zones, wherein the evacuation pre-plan is based at least in part on data entered by a user or retrieved from a datastore, special conditions, critical evacuation facilities, traffic control points and resources; and
generating, based at least in part on the evacuation pre-plan, one or more reports depicted routes, structures, exit points that were predefined for the particular pre-defined zones.

15. The system of claim 1, further comprising the operations of:
triggering one or more actions based at least in part on an actual or simulated incident, wherein the perimeter of the incident moves about one or more predefined zones.

16. The system of claim 1, further comprising the operations of:
providing an application programming interface having a function for allowing requests of information related to a particular zone based at least in part on a received zone identifier; and
providing a response including one or more of a count value for an estimated day population, an estimated night population, an estimated number of vehicles located in the zone during a day time period, an estimated number of vehicles located in the zone during a night period, a number of structures or address points, an array of geo-locations of traffic control points, an array of geo-locations of arrival points, and an array of zone routes.

17. The system of claim 1, further comprising the operations of:
displaying, via the user interface, a different incident types for selection, wherein the incident types include one or more of a fire, flood, active shooter, hazardous material, and or dam inundation;
receiving a selection of the incident type, a text input describing the incident, and a time value for the incident; and
receiving a location for the occurrence of the incident;
creating a training incident simulation based at least in part on the selected incident type and location for the occurrence of the incident; and
simulating the training incident via the user interface, wherein the training incident is displayed via the interface occurring in one or more predefined zones near the received location.

18. The system of claim 18, further comprising the operations of:
displaying, via the user interface, different communication channels for selection;
receiving a selection of one or more communication channels; and
assigning the selected communication channels for distribution of information associated with the training incident.

19. The system of claim 1, further comprising the operations of:
displaying, via the user interface, a group of the predetermined zones to a first group of one or more users, and displaying zone attributes to the first group of one or more user where the users have similar viewing privileges, wherein the zone attributes include traffic control points, evacuation arrival points and/or evacuation routes; and
displaying, via the user interface, the group of predetermined zones to a second group of one or more users, and not displaying the zone attributes to the second group of one or more users.

20. A computer-implemented method comprising the operations of:
displaying, via a user interface, a map of a geographical area, the geographical area having multiple predefined contiguous zones, wherein a zone defines an area of the map having geographic boundaries, wherein the map displays a road network and multiple building structures, and wherein the user interface is configured for receiving a selection of one or more of the predefined contiguous zones, and wherein the user interface is configured for modifying one or more attributes associated with a particular zone.
